(19) United States
(12) Patent Application Publication
(10) Pub. No.: US 2026/0260950 A1
(43) Pub. Date: Sep. 3, 2026

(54) STACKING DEVICE AND METHOD FOR MANUFACTURING ALL-SOLID-STATE BATTERY USING THE SAME

(71) Applicant: SAMSUNG SDI CO., LTD., Yongin-si, Gyeonggi-do (KR)

(72) Inventor: Daeyoung JI, Yongin-si (KR)

(21) Appl. No.: 18/994,505

(22) PCT Filed: Feb. 26, 2024
(86) PCT No.: PCT/KR2024/002451

§ 371 Date: Jan. 14, 2025

(30) Foreign Application Priority Data
Sep. 15, 2023 (KR) 10-2023-0123445

(51) Int. Cl. H01M 10/0585; B65H 5/12; B65H 37/04; H01M 10/0562

(52) U.S. Cl. CPC H01M 10/0585; B65H 5/12; B65H 37/04; H01M 10/0562

(57) ABSTRACT

The present invention relates to a stacking device and a method for manufacturing an all-solid-state battery using the same, and more particularly, a stacking device including a stacking table including a stage and a rotary unit, wherein the rotary unit is configured to enable the stage to rotate and cycle through a first position, a second position, a third position, and a fourth position, a first loading unit positioned adjacent to the first position, and configured to stack a first sheet on the stage, a second loading unit positioned adjacent to the second position, and configured to stack a second sheet on the stage, a third loading unit positioned adjacent to the first position, and configured to stack a third sheet on the stage, a first discharge gripper positioned adjacent to the fourth position, and a pressing unit positioned adjacent to the first discharge gripper.

### TECHNICAL FIELD

The present invention relates to a stacking device and a method for manufacturing an all-solid-state battery using the same, and more particularly, to a stacking device and a stacking method, which are capable of continuously stacking sheets on a rotating stage.

### BACKGROUND ART

Lately, extensive efforts have been made to develop batteries having high energy density and enhanced safety in response to industrial demand. For example, lithium ion batteries have been put to practical use in automobiles, as well as information related appliances and communication devices. In the field of automobiles, safety is particularly stressed because failures are highly likely to cause harm to lives.

Meanwhile, currently available lithium ion batteries include an electrolyte solution containing a combustible organic dispersion medium, and accordingly, there is a chance of either overheating or fire from short circuits. All-solid-state batteries replacing an electrolyte solution with a solid electrolyte are now being suggested to prevent those concerns above. The all-solid-state batteries use no combustible organic dispersion medium, and may thus have significantly reduced chances of causing fires or explosions even when short circuits take place. Therefore, such all-solid batteries provide far greater safety than lithium ion batteries using electrolyte solutions.

### DISCLOSURE OF THE INVENTION

### Technical Problem

The present invention provides a stacking device capable of continuously stacking sheets constituting an all-solid-state battery.

The present invention also provides a method for manufacturing an all-solid-state battery using the stacking device described above.

### TECHNICAL SOLUTION

A stacking device according to an embodiment of the present invention may include a stacking table including a stage and a rotary unit, wherein the rotary unit is configured to enable the stage to rotate and cycle through a first position, a second position, a third position, and a fourth position, a first loading unit positioned adjacent to the first position and configured to stack a first sheet on the stage, a second loading unit positioned adjacent to the second position and configured to stack a second sheet on the stage, a third loading unit positioned adjacent to the first position and configured to stack a third sheet on the stage, a first discharge gripper positioned adjacent to the fourth position, and a pressing unit positioned adjacent to the first discharge gripper. The first discharge gripper may be configured to transfer a stack body including the first to third sheets from the stage to the pressing unit, and the pressing unit may be configured to perform a pressing process on the stack body.

A method for manufacturing an all-solid-state battery according to another embodiment of the present invention may include stacking a first sheet on a stage at a first position, stacking a second sheet on the stage at a second position, stacking a third sheet on the stage at a third position, and performing a pressing process on a stack body including the first to third sheets. The stage may rotate and cycle through the first position, the second position, and the third position.

### Advantageous Effects

A stacking device according to the present invention may enable a stage to rotate and cycle to continuously stack sheets. A pressing unit may receive a stack body and form an all-solid-state battery through a single pressing process. Accordingly, the process of manufacturing an all-solid-state battery may be efficiently performed.

A stacking device according to the present invention may stack monocells or stack negative electrode layers/positive electrode layers. That is, even when a sheet is in a form of a monocell or in a form of an electrode layer, the stacking process may be performed continuously without limitation.

### BRIEF DESCRIPTION OF THE DRAWINGS

FIGS. 1 and 2 are each a cross-sectional view for describing all-solid-state batteries according to embodiments of the present invention;

FIG. 3 is a plan view for describing a stacking device of all-solid-state batteries according to embodiments of the present invention;

FIGS. 4 to 8 are cross-sectional views for describing a method for manufacturing all-solid-state batteries according to embodiments of the present invention;

FIG. 9 is a plan view for describing another embodiment of a first loading unit of the stacking device from FIG. 3; and

FIGS. 10 to 15 are cross-sectional views for describing a method for manufacturing all-solid-state batteries according to embodiments of the present invention.

### MODE FOR CARRYING OUT THE INVENTION

In order to sufficiently understand the configuration and effects of the present invention, preferred embodiments of the present invention will be described with reference to the accompanying drawings. It should be noted, however, that the present invention is not limited to the following embodiments, and may be implemented in various forms and variously modified. The embodiments herein are provided so that present invention will be thorough and complete and will fully convey the scope of the present invention to those skilled in the art.

Herein, it will be understood that when a component is referred to as being on another component, the component may be directly on another component, or an intervening third component may be present. In addition, in the drawings, thicknesses of components are exaggerated for effectively describing technical contents. Like reference numerals refer to like elements throughout.

The embodiments described herein will be explained with reference to the cross-sectional views, plan views, and/or perspective views as ideal example views of the present invention. Although the terms such as first, second, and third are used to describe various components in various embodiments herein, the components should not be limited to these terms. These terms are used only to distinguish one component from another component. Embodiments described and exemplified herein include complementary embodiments thereof.

Terms used herein are not for limiting the present invention but for describing the embodiments. As used herein, the singular forms include the plural forms as well, unless the context clearly indicates otherwise. The meaning of “comprises” and/or “comprising” used herein does not exclude the presence or addition of one or more other components besides a mentioned component.

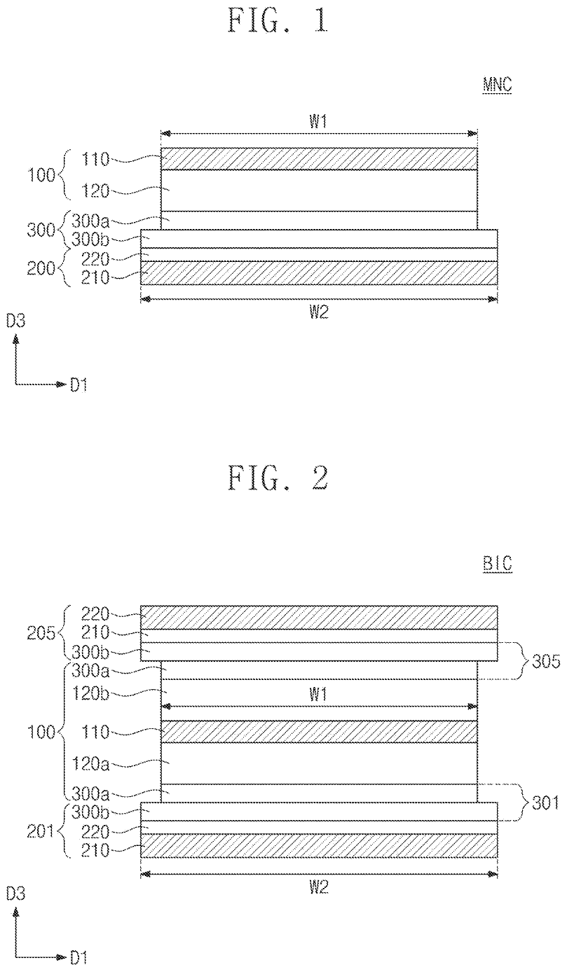

FIGS. 1 and 2 are each a cross-sectional view for describing all-solid-state batteries according to embodiments of the present invention. Referring to FIG. 1, a monocell MNC of an all-solid-state battery according to an embodiment of the present invention is presented as an example. The monocell MNC may include a positive electrode layer 100, a negative electrode layer 200 facing the positive electrode layer 100, and a solid electrolyte layer 300 disposed between the positive electrode layer 100 and the negative electrode layer 200. However, the embodiment of the present invention is not limited thereto, and the monocell MNC may further include an additional functional layer disposed between the positive electrode layer 100 and the solid electrolyte layer 300 or between the negative electrode layer 200 and the solid electrolyte layer 300, such as an adhesion enhancing layer.

The positive electrode layer 100 may include a positive electrode current collector 110 and a positive electrode active material layer 120 on the positive electrode current collector 110. The positive electrode active material layer 120 may include a positive electrode active material, a solid electrolyte, a conductive material, and a binder.

The positive electrode current collector 110 may provide a reference surface on which the positive electrode active material layer 120 is disposed. The positive electrode current collector 110 may be in the form of a plate or a foil. For example, the positive electrode current collector 110 may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Unlike what is shown in FIG. 1, the positive electrode current collector 110 may not be provided in an embodiment of the present invention. Although not shown, a carbon layer having a thickness of about 0.1 μm to about 4 μm may be further disposed between the positive electrode current collector 110 and the positive electrode active material layer 120 to increase binding strength between the positive electrode current collector 110 and the positive electrode active material layer 120.

The positive electrode active material may be a material capable of reversibly absorbing and desorbing lithium ions. For example, the positive electrode active material may include a lithium transition metal oxide such as lithium cobalt oxide (LCO), lithium nickel oxide, lithium nickel cobalt oxide, lithium nickel cobalt aluminum oxide (NCA), lithium nickel cobalt manganate (NCM), lithium manganate, or lithium iron phosphate; nickel sulfide; copper sulfide; lithium sulfide; iron oxide; or vanadium oxide, but the embodiment of the present invention is not limited thereto. The positive electrode active material may be used alone or may be a mixture of two or more types.

The lithium transition metal oxide may be, for example, a compound represented by any one among LiₐA_{1-b}B_{b}D₂ (0.90≤a≤1, 0≤b≤0.5), LiₐE_{1-b}B_{b}O_{2-c}D_{c} (0.90≤a≤1, 0≤b≤0.5, 0≤c≤0.05), LiE_{2-b}B_{b}O_{4-c}D_{c} (0≤b≤0.5, 0≤c≤0.05), LiₐNi_{1-b-c}Co_{b}B_{c}Dₐ (0.90≤a≤1, 0≤b≤0.5, 0≤c≤0.05, 0<a<2), LiₐNi_{1-b-c}Co_{b}B_{c}O₂₋ₐFₐ (0.90≤a≤1, 0≤b≤0.5, 0≤c≤0.05, 0<a<2), LiₐNi_{1-b-c}Mn_{b}B_{c}Dₐ (0.9≤a≤1, 0≤b≤0.5, 0≤c≤0.05, 0<a≤2), LiₐNi_{1-b-c}Mn_{b}B_{c}O₂₋ₐFₐ (0.90≤a≤1, 0≤b≤0.5, 0≤c≤0.05, 0<a<2), LiₐNi_{b}E_{c}G_{d}O₂(0.90≤a≤1 , 0≤b≤0.9, 0≤c≤0.5, 0.001≤d≤0.1), LiₐNi_{b}C_{c}Mn_{d}GeO₂(0.90≤a≤1, 0≤b≤0.9, 0≤c≤0.5, 0≤d≤0.5, 0.001≤e≤0.1), LiₐNiG_{b}O₂ (0.9≤a≤1, 0.001≤b≤0.1), LiₐCoG_{b}O₂(0.90≤a≤1, 0.001≤b≤0.1), LiₐMnG_{b}O₂(0.90≤a≤1, 0.001≤b≤0.1), LiₐMn₂GbO₄(0.90≤a≤1, 0.001≤b≤0.1), QO₂, QS₂, LiQS₂, V₂O₅, LiV₂O₅, LiIO₂, LiNiVO₄, Li_{3-f}J₂(PO₄)₃ (0≤f≤2), Li_{3-f}Fe₂(PO₄)₃ (0≤f≤2), and LiFePO₄. In the compounds above, capital “A” is nickel (Ni), cobalt (Co), manganese (Mn), or a combination thereof; capital “B” is aluminum (Al), nickel (Ni), cobalt (Co), manganese (Mn), chromium (Cr), iron (Fe), magnesium (Mg), strontium (Sr), vanadium (V), a rare earth element, or a combination thereof; capital “D” is oxygen (O), fluorine (F), sulfur(S), phosphorus (P), or a combination thereof; capital “E” is cobalt (Co), manganese (Mn), or a combination thereof; capital “F” is fluorine (F), sulfur(S), phosphorus (P), or a combination thereof; capital “G” is (AI), chromium (Cr), manganese (Mn), iron (Fe), magnesium (Mg), lanthanum (La), cerium (Ce), strontium (Sr), vanadium (V), or a combination thereof; capital “Q” is titanium (Ti), molybdenum (Mo), manganese (Mn), or a combination thereof; capital “I” is chromium (Cr), vanadium (V), iron (Fe), scandium (Sc), yttrium (Y), or a combination thereof; and capital “J” is vanadium (V), chromium (Cr), manganese (Mn), cobalt (Co), nickel (Ni), copper (Cu), or a combination thereof.

The positive electrode active material may include, for example, a lithium salt of the transition metal oxide that has a layered rock salt type structure among the examples of the lithium transition metal oxide. For example, the “layered rock salt type structure” indicates a structure in which oxygen atomic layers and metal atomic layers are alternately arranged regularly in a <111> direction of a cubic rock salt type structure, and as a result, each atomic layer forms a two-dimensional plane. The “cubic rock salt type structure” indicates a sodium chloride (NaCl) type structure, which is one type of crystal structures, and in particular, a structure in which face centered cubic (fcc) lattices formed by respective anions and cations are misaligned with respect to each other by ½ of the ridge of a unit lattice. The lithium transition metal oxide having this layered rock salt type structure may be a ternary lithium transition metal oxide, such as LiNiₓCo_{y}Al_{z}O₂ (NCA) or LiNiₓCo_{y}Mn_{z}O₂ (NCM) (0<x<1, 0<y<1, 0<z<1, x+y+z=1). When the positive electrode active material includes a ternary lithium transition metal oxide having a layered rock salt type structure, the monocell MNC may have greater energy density and improved thermal stability.

The above-described compounds included in the positive electrode active material may be covered by a coating layer (not shown). The positive electrode active material may also be used as a mixture of the above-described compounds and a compound to which a coating layer is added. Meanwhile, the coating layer added to a surface of the positive electrode active material may include, for example, oxide, hydroxide, oxyhydroxide, oxycarbonate, or hydroxycarbonate of the following coating elements. The compounds forming the coating layer may be amorphous or crystalline. The coating elements included in the coating layer may be Mg, Al, Co, K, Na, Ca, Si, Ti, V, Sn, Ge, Ga, B, As, Zr, or a mixture thereof. The coating layer may include, for example, Li₂O—ZrO₂ (LZO). The coating layer may be formed using any method that does not adversely affect the physical properties of the positive electrode active material. For example, the coating layer may be formed using a spray coating method or a dipping method.

When the positive electrode active material includes nickel (Ni) as a ternary lithium transition metal oxide such as NCA or NCM, the capacity density of the monocell MNC increases, and thus the metal elution of the positive electrode active material may be reduced in a charged state. Accordingly, the monocell MNC may have improved cycle characteristics in the charged state. Meanwhile, the “cycle characteristics” are characteristics that indicate the degree to which the monocell MNC is deteriorated due to charging/discharging of the monocell MNC, and in an monocell MNC having high cycle characteristics, the degree of deterioration caused by charging/discharging may be insignificant, and in an monocell MNC having low cycle characteristics, the degree of deterioration caused by charging/discharging may be significant.

The shape of the positive electrode active material may include, for example, particle shapes such as spheres and ellipsoids. The particle size and content of the positive electrode active material are not particularly limited.

The solid electrolyte may include a sulfide-based solid electrolyte having excellent lithium ion conductivity characteristics. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers, and capital “Z” is one of Ge, Zn, or Ga), Li₂S—GeS₂, Li₂S—SiS₂—Li₃PO₄, Li₂S—SiS₂—LiₚMO_{q} (where p and q are positive numbers, and “M” is one of P, Si, Ge, B, Al, Ga, or In), Li₇₋ₓPS₆₋ₓClₓ (0—x≤2), Li₇₋ₓPS₆₋ₓBrₓ (0≤x≤2), and Li₇₋ₓPS₆₋ₓ—Iₓ (0≤x≤2).

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of about 1.5 g/cc to about 2.0 g/cc. The argyrodite-type solid electrolyte, when having a density of about 1.5 g/cc or greater, may allow all-solid-state batteries to have reduced internal resistance and prevent solid electrolyte membranes from showing defects such as penetration and short-circuits caused by formation of lithium dendrites. The solid electrolyte may have an elastic modulus of, for example, about 15 GPa to about 35 GPa.

The solid electrolyte included in the positive electrode active material layer 120 may have a smaller average (median) particle size (D50) than the solid electrolyte included in the solid electrolyte layer 300. For example, the average (median) particle size (D50) of the solid electrolyte included in the positive electrode active material layer 120 may be about 90% or less, about 80% or less, about 70% or less, about 60% or less, about 50% or less, about 40% or less, about 30% or less, or about 20% or less of the average (median) particle size (D50) of the solid electrolyte included in the solid electrolyte layer 300. Meanwhile, the average (median) particle size (D50) may be a median diameter measured using a laser particle size distribution meter.

The positive electrode active material layer 120 may include a conductive material. The conductive material has conductivity without causing chemical changes in the monocell MNC, and may thus increase the conductivity of the positive electrode active material and the solid electrolyte. The conductive material may include a carbon-based material. The conductive material may include, for example, at least one selected from graphite, carbon black, acetylene black, carbon nanofibers, and carbon nanotubes.

The positive electrode active material layer 120 may further include a binder. The binder may bond the positive electrode active material, the solid electrolyte, and the conductive material contained in the positive electrode active material layer 120, and may include a material designed to improve bonding strength with the positive electrode current collector 110. The binder may include, for example, polyvinylidene fluoride, styrene butadiene rubber (SBR), polytetrafluoroethylene, polyvinylidenefluoride, vinylidene fluoride/hexafluoropropylene copolymer, polyacrylonitrile, or polymethyl methacrylate.

The positive electrode active material layer 120 may include about 85 parts by weight to about 92 parts by weight of the positive electrode active material with respect to 100 parts by weight of the positive electrode active material, the solid electrolyte, the conductive material, and the binder. The positive electrode active material layer 120 may include about 0.5 parts by weight to about 1.5 parts by weight of the binder.

In the positive electrode active material layer 120, the conductive material may be present in an amount of about 1 part by weight to about 50 parts by weight with respect to 100 parts by weight of the solid electrolyte. When the conductive material is present in an amount of less than about 1 part by weight with respect to 100 parts by weight of the solid electrolyte, the positive electrode active material layer 120 may have reduced electrical conductivity. When the conductive material is present in an amount of greater than 50 parts by weight with respect to 100 parts by weight of the solid electrolyte, the proportion of the conductive material goes up too high, and thus a coating layer covering a surface of the solid electrolyte may not be properly formed.

According to embodiments, the positive electrode active material layer 120 may further include at least one additive selected from the group consisting of a filler, a coating agent, a dispersant, and an ion conductive auxiliary agent, in addition to the positive electrode active material, the solid electrolyte, the conductive material, and the binder described above.

The solid electrolyte layer 300 may be disposed between the positive electrode layer 100 and the negative electrode layer 200 and may include a sulfide-based solid electrolyte having excellent lithium ion conductivity characteristics. The solid electrolyte included in the solid electrolyte layer 300 may be the same as or different from any one of the materials that may be included in the solid electrolyte included in the positive electrode active material layer 120 described above.

The solid electrolyte layer 300 of an embodiment may include a sulfide-based solid electrolyte. The sulfide-based solid electrolyte may be prepared by subjecting starting materials (e.g., Li₂S, P₂S₅) to melt-quenching or mechanical milling. In addition, subsequently, the resulting product may be heat-treated. The solid electrolyte may be amorphous, crystalline, or a mixture thereof. In addition, the solid electrolyte may include at least sulfur(S), phosphorus (P), and lithium (Li), as component elements among the sulfide-based solid electrolyte materials described above. For example, the solid electrolyte may be a material containing Li₂S—P₂S₅. When the material containing Li₂S—P₅S₅ is used as a sulfide-based solid electrolyte material that forms the solid electrolyte, a mixing molar ratio of Li₂S and P₂S₅ (Li₂S:P₂S₅) is, for example, in a range of about 50:50 to about 90:10.

The sulfide-based solid electrolyte may be an argyrodite-type compound containing at least one selected from, for example, Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). In particular, the sulfide-based solid electrolyte may be an argyrodite-type compound containing at least one selected from, for example, Li₆PS₅Cl, Li₆PS₅Br, and Li₆PS₅I. The argyrodite-type solid electrolyte may have a density of about 1.5 g/cc to about 2.0 g/cc. The argyrodite-type solid electrolyte, when having a density of about 1.5 g/cc or greater, may allow all-solid-state batteries to have reduced internal resistance and prevent solid electrolyte membranes from showing defects such as penetration and short-circuits caused by formation of lithium dendrites. The solid electrolyte has an elastic modulus of, for example, about 15 GPa to about 35 GPa.

The solid electrolyte layer 300 may further include a binder. The binder in the solid electrolyte layer 300 is, for example, styrene butadiene rubber (SBR), polytetrafluoroethylene, polyvinylidene fluoride, and polyethylene, but the embodiment of the present invention is not limited thereto. The binder of the solid electrolyte layer 300 may be the same as or different from the binder included in the positive electrode active material layer 120 or the binder included in the negative electrode coating layer 220.

The negative electrode layer 200 may include a negative electrode current collector 210 and a negative electrode coating layer 220 on the negative electrode current collector 210. The negative electrode current collector 210 may provide a reference surface on which the negative electrode coating layer 220 is disposed. For example, the negative electrode current collector 210 may include a material that is not reactive with lithium, i.e., does not form either an alloy or a compound with lithium. For example, the negative electrode current collector 210 may include at least one metal selected from the group consisting of copper (Cu), stainless steel, titanium (Ti), iron (Fe), cobalt (Co), and nickel (Ni). The negative electrode current collector 210 may have a thickness of about 1 μm to about 20 μm, more specifically about 5 μm to about 15 μm, more specifically about 7 um to about 10 μm.

The negative electrode current collector 210 may be composed of one of the above-described metals, or may include an alloy of two or more metals or a coating material. The negative electrode current collector 210 may be, for example, in the form of a plate or a foil. Meanwhile, in an embodiment, the negative electrode current collector 210 may not be provided.

The negative electrode coating layer 220 may allow lithium metal to grow between the negative electrode coating layer 220 and the negative electrode current collector 210 when the monocell MNC is charged. The negative electrode coating layer 220 may serve as a protection layer for lithium metal and also inhibit the deposition and growth of lithium dendrites.

The negative electrode coating layer 220 may include metal and carbon. For example, the negative electrode coating layer 220 may include at least one metal selected from the group consisting of gold (Au), platinum (Pt), palladium (Pd), silicon (Si), silver (Ag), aluminum (Al), bismuth (Bi), tin (Sn), and zinc (Zn). The negative electrode coating layer 220 may include at least one carbon selected from the group consisting of carbon black, acetylene black, furnace black, ketjen black, and graphene. In an embodiment, the negative electrode coating layer 220 may include a mixture of carbon black and silver (Ag).

The negative electrode coating layer 220 may further include other additives in addition to metal and carbon. The negative electrode coating layer 220 may further include at least one additive selected from the group consisting of, for example, a binder, a filler, a coating agent, a dispersant, and an ion conductive auxiliary agent.

The negative electrode coating layer 220 may have a smaller thickness than the positive electrode active material layer 120. The thickness of the negative electrode coating layer 220, is, for example, about 50% or less, about 40% or less, about 30% or less, about 20% or less, about 10% or less, or about 5% or less of the thickness of the positive electrode active material layer 120. The negative electrode coating layer 220 may have a thickness of, for example, about 1 μm to about 20 μm, about 2 μm to about 10 μm, or about 3 μm to about 7 μm. When the negative electrode coating layer 220 is too thin, the lithium dendrites formed between the negative electrode coating layer 220 and the negative electrode current collector 210 break down the negative electrode coating layer 220, and this may cause the monocell MNC to have degraded cycle characteristics. When the negative electrode coating layer 220 is too thick, the monocell MINC has reduced energy density and greater internal resistance due to the negative electrode coating layer 220, and this may cause the monocell MNC to have degraded cycle characteristics.

Meanwhile, although not shown, a carbon layer designed to improve adhesion between the negative electrode coating layer 220 and the solid electrolyte layer 300 may be further included.

According to embodiments of the present invention, a width (or breadth) of the positive electrode layer 100 may be smaller than a width (or breadth) of the negative electrode layer 200. For example, the positive electrode layer 100 may have a first width W1 in the first direction D1, and the negative electrode layer 200 may have a second width W2 in the first direction D1. The first width W1 may be smaller than the second width W2.

According to embodiments of the present invention, the solid electrolyte layer 300 may include a positive electrode electrolyte layer 300a and a negative electrode electrolyte layer 300b. The positive electrode electrolyte layer 300a and the negative electrode electrolyte layer 300b may be stacked to form one solid electrolyte layer 300. The positive electrode electrolyte layer 300a may be in contact with the positive electrode active material layer 120, and the negative electrode electrolyte layer 300b may be in contact with the negative electrode coating layer 220.

For example, the positive electrode electrolyte layer 300a and the negative electrode electrolyte layer 300b may include solid electrolytes of the same composition. For another example, the positive electrode electrolyte layer 300a and the negative electrode electrolyte layer 300b may include solid electrolytes of different compositions.

The positive electrode electrolyte layer 300a may have a first width W1, and the negative electrode electrolyte layer 300b may have a second width W2. That is, the width (or breadth) of the positive electrode electrolyte layer 300a may be smaller than the width (or breadth) of the negative electrode electrolyte layer 300b.

Referring to FIG. 2, a bi-cell BIC of the all-solid-state battery according to an embodiment of the present invention is presented as an example. The bi-cell BIC may include a first negative electrode layer 201, a second negative electrode layer 205, and a positive electrode layer 100 sandwiched between the first negative electrode layer 201 and the second negative electrode layer 205.

The first negative electrode layer 201 and the second negative electrode layer 205 may include a negative electrode current collector 210, a negative electrode coating layer 220 on the negative electrode current collector 210, and a negative electrode electrolyte layer 300b on the negative electrode coating layer 220. The negative electrode current collector 210 and the negative electrode coating layer 220 may be the same as the negative electrode current collector 210 and the negative electrode current collector 210 described above with reference to FIG. 1, respectively. The negative electrode electrolyte layer 300b may be the same as the solid electrolyte layer 300 described above with reference to FIG. 1. The negative electrode electrolyte layer 300b may be in direct contact with the negative electrode coating layer 220.

The positive electrode layer 100 may include a first positive electrode active material layer 120a, a second positive electrode active material layer 120b, and a positive electrode current collector 110 disposed between the first positive electrode active material layer 120a and the second positive electrode active material layer 120b. The first positive electrode active material layer 120a and the second positive electrode active material layer 120b may each have the same composition or different compositions.

The positive electrode layer 100 may further include a positive electrode electrolyte layer 300a provided on each of the first positive electrode active material layer 120a and the second positive electrode active material layer 120b. In an embodiment, the positive electrode layer 100 may include a pair of positive electrode electrolyte layers 300a. The first positive electrode active material layer 120a and the second positive electrode active material layer 120b may be sandwiched between the pair of positive electrode electrolyte layers 300a. One of the pair of positive electrode electrolyte layers 300a may be in contact with the first positive electrode active material layer 120a. The other of the pair of positive electrode electrolyte layers 300a may be in contact with the second positive electrode active material layer 120b. The positive electrode electrolyte layer 300a may be the same as the solid electrolyte layer 300 described above with reference to FIG. 1.

The positive electrode electrolyte layer 300a and the negative electrode electrolyte layer 300b disposed between the first positive electrode active material layer 120a and the negative electrode coating layer 220 of the first negative electrode layer 201 may constitute a first solid electrolyte layer 301. The positive electrode electrolyte layer 300a and the negative electrode electrolyte layer 300b disposed between the second positive electrode active material layer 120b and the negative electrode coating layer 220 of the second negative electrode layer 205 may constitute a second solid electrolyte layer 305.

According to some embodiments, the positive electrode layer 100 may have a first width W1, and each of the first negative electrode layer 201 and the second negative electrode layer 205 may have a second width W2. The first width W1 may be smaller than the second width W2. Since the width of the positive electrode layer 100 is smaller than the width of each of the first negative electrode layer 201 and the second negative electrode layer 205, a gasket may be further provided around the positive electrode layer 100 to make up for the difference.

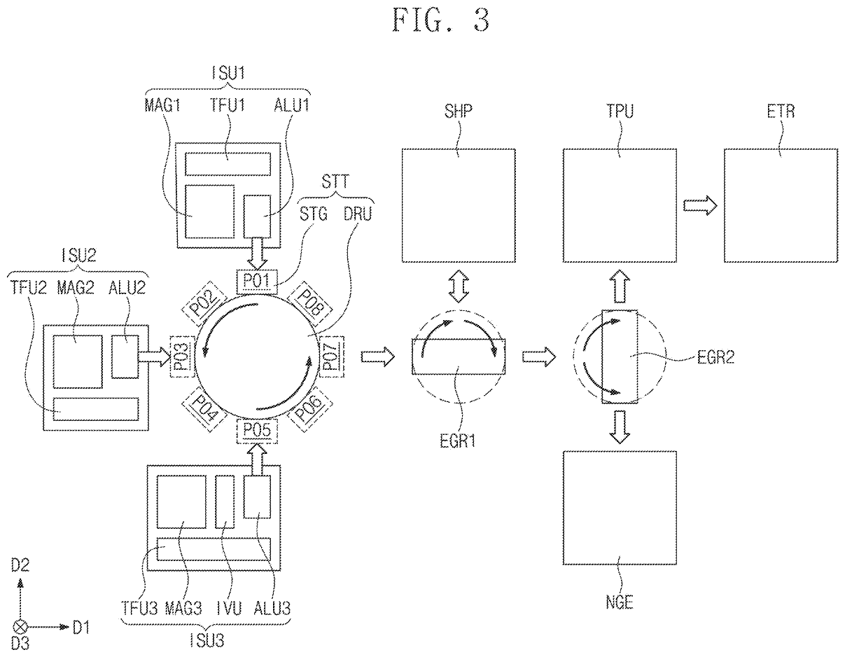

FIG. 3 is a plan view for describing a stacking device for all-solid-state batteries according to embodiments of the present invention. Referring to FIG. 3, the stacking device may include a first loading unit ISU1, a second loading unit ISU2, a third loading unit ISU3, and a stacking table STT. The stacking device may further include a first discharge gripper EGR1, a pressing unit SHP, a second discharge gripper EGR2, a defect discharge unit NGE, a taping unit TPU, and a cell discharge unit ETR.

The first to third loading units ISU1-ISU3 may be sequentially disposed in a counterclockwise direction along the circumference of the stacking table STT. The first loading unit ISU1 may include a first magazine unit MAG1, a first transfer unit TFU1, and a first alignment unit ALU1. A plurality of first sheets may be loaded into the first magazine unit MAG1. The first magazine unit MAG1 may be configured to sequentially supply a plurality of first sheets.

The first transfer unit TFU1 may be configured to transfer the first sheet supplied from the first magazine unit MAG1 onto the first alignment unit ALU1. For example, the first transfer unit TFU1 may have the form of a robot arm capable of gripping and transferring the first sheet.

The first alignment unit ALU1 may be configured to measure the alignment of the first sheet transferred through the first transfer unit TFU1. For example, the first alignment unit ALU1 may examine the alignment of the first sheet through vision. Through the first alignment unit ALU1, the first sheet may be accurately aligned on a stage STG of the stacking table STT, which will be described later.

The second loading unit ISU2 may include a second magazine unit MAG2, a second transfer unit TFU2, and a second alignment unit ALU2. A plurality of second sheets may be loaded into the second magazine unit MAG2. The second magazine unit MAG2 may be configured to sequentially supply a plurality of second sheets. The second transfer unit TFU2 may be configured to transfer the second sheet supplied from the second magazine unit MAG2 onto the second alignment unit ALU2. The second alignment unit ALU2 may be configured to measure the alignment of the second sheet transferred through the second transfer unit TFU2.

The third loading unit ISU3 may include a third magazine unit MAG3, a third transfer unit TFU3, an inversion unit IVU, and a third alignment unit ALU3. A plurality of third sheets may be loaded into the third magazine unit MAG3. The third magazine unit MAG3 may be configured to sequentially supply a plurality of third sheets. The third transfer device TFU3 may be configured to transfer the third sheet supplied from the third magazine unit MAG3 onto the third alignment unit ALU3. The inversion unit IVU may be configured to invert the third sheet transferred through the third transfer unit TFU3 upside down. That is, the third sheet may be turned upside down through the inversion unit IVU. The third alignment unit ALU3 may be configured to measure the alignment of the inverted third sheet.

The stacking table STT may include the stage STG and a rotation unit DRU. The stage STG may be connected to the rotation unit DRU and may rotate 360 degrees. For example, the rotation unit DRU may be configured to enable the stage STG to rotate counterclockwise. The rotation unit DRU may have the form of a rotatable index table. For example, the rotation unit DRU may include a rotating plate and a motor configured to drive the rotating plate.

The stage STG may sequentially move onto first to eighth positions PO1-PO8 through the rotation unit DRU. Specifically, the first sheet supplied from the first loading unit ISU1 may be stacked on the stage STG at the first position PO1. On the stage STG subjected to moving to the second position PO2, the alignment between the first sheet and the stage STG may be examined.

The stage STG may move from the second position PO2 to the third position PO3. The second sheet supplied from the second loading unit ISU2 may be stacked on the stage STG at the third position PO3. The second sheet may be stacked on the first sheet. On the stage STG subjected to moving to the fourth position PO4, the alignment between the second sheet and the stage STG may be examined.

The stage STG may move from the fourth position PO4 to the fifth position PO5. On the stage STG at the fifth position PO5, the inverted third sheet supplied from the third loading unit ISU3 may be stacked. The inverted third sheet may be stacked on the second sheet. On the stage STG subjected to moving to the sixth position PO6, the alignment between the third sheet and the stage STG may be examined.

The stage STG may move from the sixth position PO6 to the seventh position PO7. At the seventh position PO7, a stack body on the stage STG may move onto the first discharge gripper EGRI.

The first discharge gripper EGR1 may be configured to transfer the stack body delivered from the stacking table STT to the pressing unit SHP. The first discharge gripper EGR1 may be configured to transfer the stack body exported from the pressing unit SHP to the second discharge gripper EGR2. The first discharge gripper EGR1 may rotate clockwise or counterclockwise while gripping the stack body.

The pressing unit SHP may be configured to press the stack body delivered from the first discharge gripper EGR1. The pressing unit SHP may press the stack body using surface pressure. The pressing unit SHP may be configured to perform a heating process together with the pressing of the stack body. That is, the pressing unit SHP may perform pressing and heating processes. For example, the pressing unit SHP may use a hydraulic method or a servomotor method. The pressing unit SHP may discharge the pressed stack body back to the first discharge gripper EGR1.

The second discharge gripper EGR2 may be configured to transfer the pressed stack body delivered from the first discharge gripper EGR1 to the taping unit TPU or the defect discharge unit NGE. The second discharge gripper EGR2 may rotate clockwise or counterclockwise while gripping the stack body. When a defect is present in the stack body, the second discharge gripper EGR2 may discharge the stack body to the defect discharge unit NGE. When there are no defects in the stack body, the second discharge gripper EGR2 may transfer the stack body to the taping unit TPU.

The taping unit TPU may be configured to tap the stack body delivered from the second discharge gripper EGR2. The taping unit TPU may wrap tape around the stack body by rotating the stack body.

The taped stack body may be discharged from the taping unit TPU to the cell discharge unit ETR. The cell discharge unit ETR may include a tray on which the stack body may be loaded. An all-solid-state battery may be manufactured using the stack body loaded in the cell discharge unit ETR.

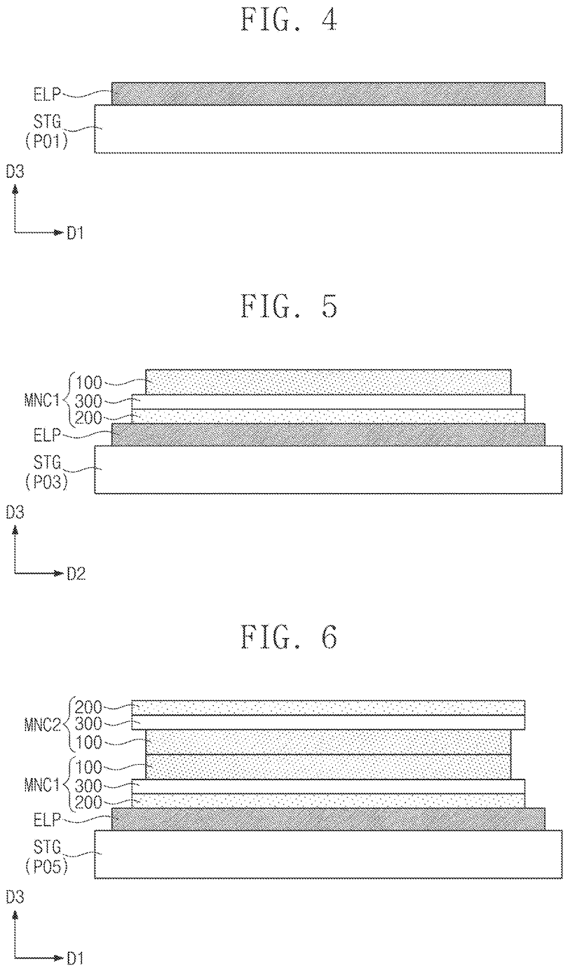

FIGS. 4 to 8 are cross-sectional views for describing a method for manufacturing all-solid-state batteries according to embodiments of the present invention. In the present embodiment, a method for manufacturing an all-solid-state battery using the above-described stacking device of FIG. 3 will be described.

Referring to FIGS. 3 and 4, an elastic pad ELP may be provided on the stage STG at the first position PO1. The elastic pad ELP may correspond to the first sheet supplied through the first loading unit ISU1.

The elastic pad ELP may relieve stress caused by changes in the volume of a battery cell during charging and discharging. The elastic pad ELP may be composed of members capable of elastic deformation. The elastic pad ELP may include a material having a lower elastic modulus than the positive electrode current collector and the negative electrode current collector. The elastic pad ELP may include an insulating material. For example, the material of the elastic pad ELP may be selected from the group consisting of fluorine resins such as epoxy resin, acrylic resin, polyimide resin, polyester resin, polypropylene resin, polyamide resin, polystyrene resin, polyvinyl chloride resin, polycarbonate resin, or PTFE, and silicone rubber.

Referring to FIGS. 3 and 5, a first monocell MNC1 may be provided on the stage STG at the third position PO3. The first monocell MNC1 may be aligned and stacked on the elastic pad ELP. The first monocell MNC1 may correspond to the second sheet supplied through the second loading unit ISU2. The first monocell MNC1 may be substantially the same as the monocell MNC described above with reference to FIG. 1. The negative electrode layer 200 of the first monocell MNC1 may be in direct contact with the elastic pad ELP. The positive electrode layer 100 of the first monocell MNC1 may be exposed upward.

Referring to FIGS. 3 and 6, a second monocell MNC2 may be provided on the stage STG at the fifth position PO5. The second monocell MNC2 may be provided in an inverted state with the positive electrode layer 100 facing downward. The second monocell MNC2 may be aligned and stacked on the first monocell MNC1. The second monocell MNC2 may correspond to an inverted third sheet supplied through the third loading unit ISU3. The second monocell MNC2 may be substantially the same as the monocell MNC described above with reference to FIG. 1. The positive electrode layer 100 of the second monocell MNC2 may be in direct contact with the positive electrode layer 100 of the first monocell MNC1. The negative electrode layer 200 of the second monocell MNC2 may be exposed upward.

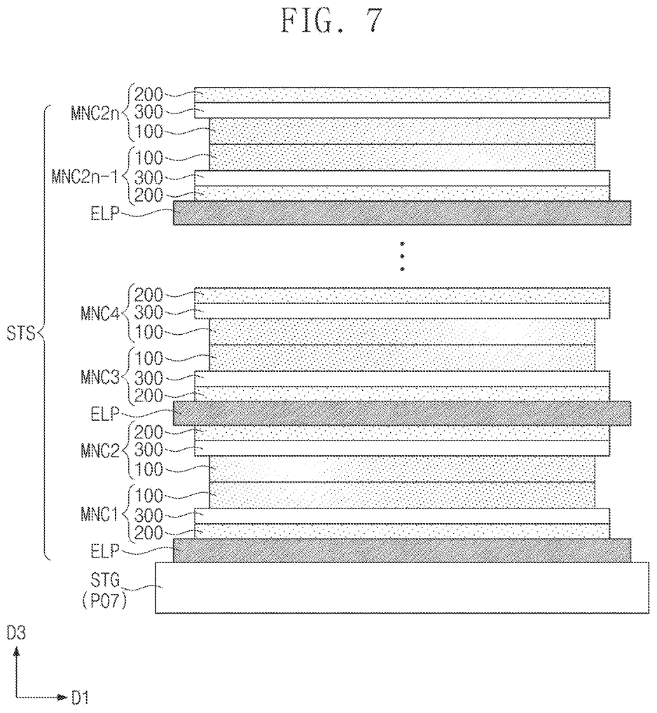

Referring to FIGS. 3 and 7, the stacking process described above with reference to FIGS. 4 to 6 may be repeatedly performed while the stage STG rotates through the rotation unit DRU. The stacking process may be performed n times. n may be an integer of 1 or greater. By performing the stacking process n times, a stack body STS may be formed on the stage STG at the seventh position PO7.

In an embodiment, the stacked body STS may include a first monocell MNC1, a second monocell MNC2, a third monocell MNC3, a fourth monocell MNC4 to a (2n-1)-th monocell MNC2n-1, and a (2n)-th monocell MNC2n. n may be an integer of 3 or greater. The stack body STS may further include a plurality of elastic pads ELP. Two monocells MNC may be sandwiched between adjacent elastic pads ELP.

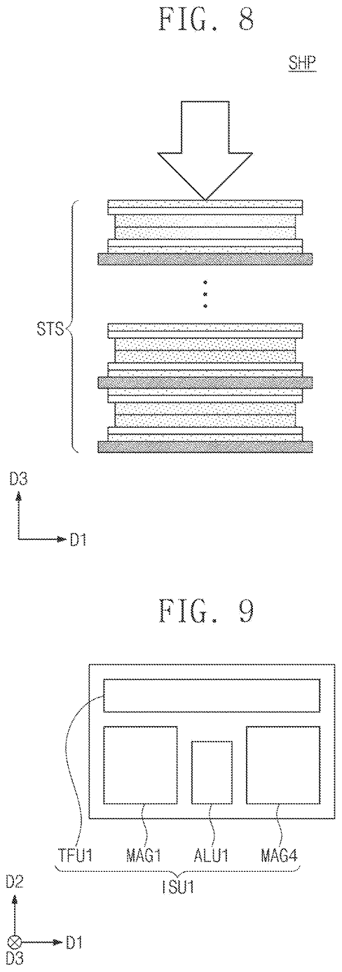

Referring to FIGS. 3 and 8, the stack STS on the stage STG at the seventh position PO7 may be transferred to the pressing unit SHP through the first discharge gripper EGRI. Pressing and heating processes may be performed on the stack body STS in the pressing unit SHP. In an embodiment, an interface between the positive electrode electrolyte layer 300a and the negative electrode electrolyte layer 300b in the stack STS may be activated through pressing and heating processes.

According to embodiments of the present invention, instead of performing the pressing and heating processes on each monocell MNC, a single process of pressing and heating process may be performed on a plurality of stacked monocells MNC. This may improve the efficiency of the process of manufacturing an all-solid-state battery.

The pressed stack body STS may be transferred to the taping unit TPU through the second discharge gripper EGR2. A taping process may be performed on the stack body STS in the taping unit TPU. The taped stack body STS may be loaded into the battery discharge unit ETR.

FIG. 9 is a plan view for describing another embodiment of a first loading unit of the stacking device from FIG. 3. Referring to FIGS. 3 and 9, the first loading unit ISU1 may further include a fourth magazine unit MAG4. A plurality of fourth sheets may be loaded into the fourth magazine unit MAG4. The fourth magazine unit MAG4 may be configured to sequentially supply a plurality of fourth sheets. The first transfer unit TFU1 may be configured to transfer the fourth sheet supplied from the fourth magazine unit MAG4 onto the first alignment unit ALU1. The first alignment unit ALU1 may be configured to measure the alignment of the fourth sheet transferred through the first transfer unit TFU1.

The first loading unit ISU1 may sequentially stack the first sheet and the fourth sheet on the stage STG at the first position PO1.

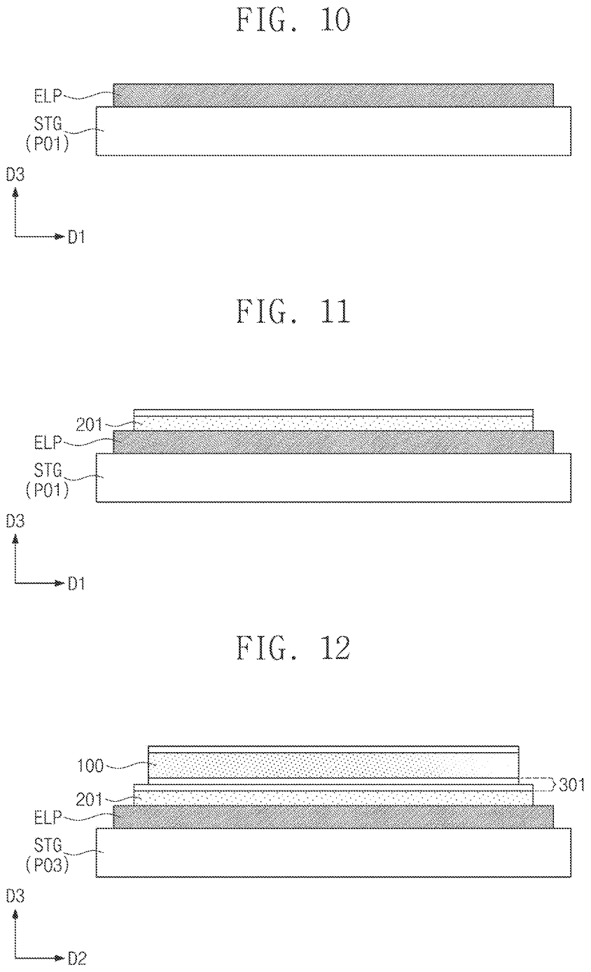

FIGS. 10 to 15 are cross-sectional views for describing a method for manufacturing all-solid-state batteries according to embodiments of the present invention. In the present embodiment, a method for manufacturing an all-solid-state battery using the above-described stacking devices of FIGS. 3 and 9 will be described.

Referring to FIGS. 3, 9, and 10, the elastic pad ELP may be provided on the stage STG at the first position PO1. The elastic pad ELP may correspond to the first sheet supplied through the first loading unit ISU1. Specifically, the elastic pad ELP may be supplied through the first magazine unit MAG1 of the first loading unit ISU1. The elastic pad ELP may relieve stress caused by changes in the volume of a battery cell during charging and discharging.

Referring to FIGS. 3, 9, and 11, the first negative electrode layer 201 may be provided on the stage STG at the first position PO1. The first negative electrode layer 201 may be aligned and stacked on the elastic pad ELP. The first negative electrode layer 201 may correspond to the fourth sheet supplied through the first loading unit ISU1. Specifically, the first negative electrode layer 201 may be supplied through the fourth magazine unit MAG4 of the first loading unit ISU1.

The first negative electrode layer 201 may be substantially the same as the first negative electrode layer 201 described above with reference to FIG. 2. The first negative electrode layer 201 may include a negative electrode current collector 210, a negative electrode coating layer 220, and a negative electrode electrolyte layer 300b that are sequentially stacked. In an embodiment of the present invention, the negative electrode coating layer 220 and the negative electrode electrolyte layer 300b may be sequentially applied onto the negative electrode current collector 210 and then pressed to prepare the first negative electrode layer 201 prepared in the fourth magazine unit MAG4. The pressing process of the first negative electrode layer 201 may be performed at a lower pressure than the pressing process to be performed in the pressing unit SHP, which will be described later.

Referring to FIGS. 3 and 12, the positive electrode layer 100 may be provided on the stage STG at the third position PO3. The positive electrode layer 100 may be aligned and stacked on the first negative electrode layer 201. The positive electrode layer 100 may correspond to the second sheet supplied through the second loading unit ISU2.

The positive electrode layer 100 may be substantially the same as the positive electrode layer 100 described above with reference to FIG. 2. The positive electrode layer 100 may include a positive electrode electrolyte layer 300a, a first positive electrode active material layer 120a, a positive electrode current collector 110, a second positive electrode active material layer 120b, and a positive electrode electrolyte layer 300a, which are sequentially stacked. In an embodiment of the present invention, the positive electrode active material layers 120a and 120b and the positive electrolyte layer 300a may be sequentially applied onto both sides of the negative electrode current collector 210 and then pressed to prepare the positive electrode layer 100 prepared in the second magazine unit MAG2. The pressing process of the positive electrode layer 100 may be performed at a lower pressure than the pressing process to be performed in the pressing unit SHP, which will be described later.

Referring to FIGS. 3 and 13, the second negative electrode layer 205 may be provided on the stage STG at the fifth position PO5. The second negative electrode layer 205 may be provided in an inverted state with the negative electrode electrolyte layer 300b facing downward. The second negative electrode layer 205 may be aligned and stacked on the positive electrode layer 100. The second negative electrode layer 205 may correspond to the inverted third sheet supplied through the third loading unit ISU3.

The second negative electrode layer 205 may be substantially the same as the second negative electrode layer 205 described above with reference to FIG. 2. The second negative electrode layer 205 may include a negative electrode electrolyte layer 300b, a negative electrode coating layer 220, and a negative electrode current collector 210, which are sequentially stacked. In an embodiment of the present invention, the negative electrode coating layer 220 and the negative electrode electrolyte layer 300b may be sequentially applied onto the negative electrode current collector 210 and then pressed to prepare the second negative electrode layer 205 prepared in the third magazine unit MAG3. The pressing process of the second negative electrode layer 205 may be performed at a lower pressure than the pressing process to be performed in the pressing unit SHP, which will be described later.

The first negative electrode layer 201, the positive electrode layer 100, and the second negative electrode layer 205 sequentially stacked on the elastic pad ELP may form a first bi-cell BIC1. The first bi-cell BIC1 may include a first solid electrolyte layer 301 and a second solid electrolyte layer 305.

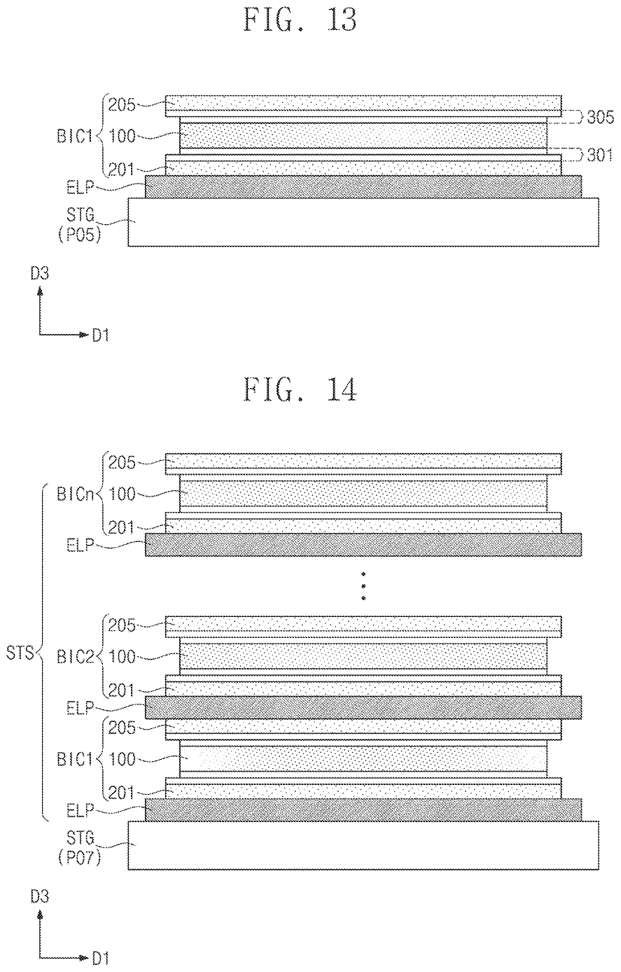

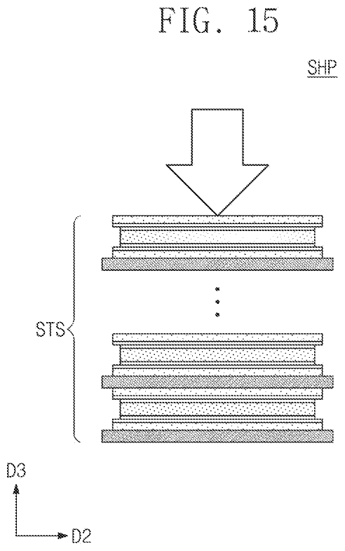

Referring to FIGS. 3 and 14, the stacking process described above with reference to FIGS. 10 to 13 may be repeatedly performed while the stage STG rotates through the rotation unit DRU. The stacking process may be performed n times. n may be an integer of 1 or greater. By performing the stacking process n times, a stack body STS may be formed on the stage STG at the seventh position PO7.

In an embodiment, the stack body STS may include a first bi-cell BIC1, a second bi-cell BIC2 to an n-th bi-cell BICn. n may be an integer of 3 or greater. The stack body STS may further include a plurality of elastic pads ELP. One bi-cell BIC may be sandwiched between adjacent elastic pads ELP.

Referring to FIGS. 3 and 15, the stack STS on the stage STG at the seventh position PO7 may be transferred to the pressing unit SHP through the first discharge gripper EGRI. Pressing and heating processes may be performed on the stack body STS in the pressing unit SHP. In an embodiment, an interface between the positive electrode electrolyte layer 300a and the negative electrode electrolyte layer 300b in the stack STS may be activated through pressing and heating processes.

According to embodiments of the present invention, instead of performing the pressing and heating processes on each bi-cell BIC, a single process of pressing and heating process may be performed on a plurality of stacked bi-cells BIC. This may improve the efficiency of the process of manufacturing an all-solid-state battery.

The pressed stack body STS may be transferred to the taping unit TPU through the second discharge gripper EGR2. A taping process may be performed on the stack body STS in the taping unit TPU. The taped stack body STS may be loaded into the battery discharge unit ETR.

Although the embodiments of the present invention have been described above with reference to the accompanying drawings, the present invention may be applied in other specific forms without changing the technical idea or essential features thereof. Therefore, the above-described embodiments are to be considered in all aspects as illustrative and not restrictive.

1. A stacking device comprising:
a stacking table including a stage and a rotary unit, wherein the rotary unit is configured to enable the stage to rotate and cycle through a first position, a second position, a third position, and a fourth position;
a first loading unit positioned adjacent to the first position, and configured to stack a first sheet on the stage;
a second loading unit positioned adjacent to the second position, and configured to stack a second sheet on the stage;
a third loading unit positioned adjacent to the third position, and configured to stack a third sheet on the stage;
a first discharge gripper positioned adjacent to the fourth position; and
a pressing unit positioned adjacent to the first discharge gripper,
wherein the first discharge gripper is configured to transfer a stack body including the first to third sheets from the stage to the pressing unit, and
the pressing unit is configured to perform a pressing process on the stack body.

2. The stacking device of claim 1, wherein the first loading unit comprises:
a first magazine unit configured to supply the first sheet;
a first transfer unit configured to transfer the first sheet; and
a first alignment unit configured to examine the alignment of the first sheet.

3. The stacking device of claim 2, wherein the first loading unit further comprises a fourth magazine unit configured to supply a fourth sheet.

4. The stacking device of claim 3, wherein;
the first sheet comprises an elastic pad;
the fourth sheet comprises a first negative electrode layer;
the second sheet comprises a positive electrode layer, and
the third sheet comprises a second negative electrode layer.

5. The stacking device of claim 1, wherein the second loading unit comprises:
a second magazine unit configured to supply the second sheet;
a second transfer unit configured to transfer the second sheet, and
a second alignment unit configured to examine the alignment of the second sheet.

6. The stacking device of claim 1, wherein the third loading unit comprises:
a third magazine unit configured to supply the third sheet;
a third transfer unit configured to transfer the third sheet;
an inverter configured to invert the third sheet; and
a third alignment unit configured to examine the alignment of the third sheet.

7. The stacking device of claim 1, further comprising:
a second discharge gripper positioned adjacent to the first discharge gripper;
a defect discharge unit configured to receive a defective stack body from the second discharge gripper; and
a taping unit configured to receive a satisfactory stack body from the second discharge gripper.

8. The stacking device of claim 1, wherein the pressing unit is configured to perform a heating process while performing the pressing process on the stack body.

9. The stacking device of claim 1, wherein:
the first sheet comprises an elastic pad;
the second sheet comprises a first monocell; and
the third sheet comprises a second monocell.

10. The stacking device of claim 9, wherein the first monocell and the second monocell each comprise:
a negative electrode layer including a negative electrode current collector and a negative electrode coating layer on the negative electrode current collector;
a positive electrode layer including a positive electrode current collector and a positive electrode active material layer on the positive electrode current collector; and
a solid electrolyte layer sandwiched between the negative electrode layer and the positive electrode layer.

11. A method for manufacturing an all-solid-state battery, the method comprising:
stacking a first sheet on a stage at a first position;
stacking a second sheet on the stage at a second position;
stacking a third sheet on the stage at a third position, and
performing a pressing process on a stack body including the first to third sheets,
wherein the stage rotates and cycles through the first position, the second position, and the third position.

12. The method of claim 11, wherein:
the first sheet comprises an elastic pad;
the second sheet comprises a first monocell; and
the third sheet comprises a second monocell.

13. The method of claim 12, wherein the first monocell and the second monocell each comprise:
a negative electrode layer including a negative electrode current collector and a negative electrode coating layer on the negative electrode current collector;
a positive electrode layer including a positive electrode current collector and a positive electrode active material layer on the positive electrode current collector; and
a solid electrolyte layer sandwiched between the negative electrode layer and the positive electrode layer.

14. The method of claim 11, further comprising stacking a fourth sheet on the stage at the third position,
wherein the fourth sheet is stacked on the first sheet.

15. The method of claim 14, wherein:
the first sheet comprises an elastic pad;
the fourth sheet comprises a first negative electrode layer;
the second sheet comprises a positive electrode layer; and
the third sheet comprises a second negative electrode layer.

16. The method of claim 15, wherein preparing each of the first negative electrode layer and the second negative electrode layer comprises:
sequentially applying a negative electrode coating layer and a negative electrode electrolyte layer onto a negative electrode current collector; and
performing a pressing process on the negative electrode current collector, the negative electrode coating layer, and the negative electrode electrolyte layer.

17. The method of claim 15, wherein preparing the positive electrode layer comprises:
sequentially applying a first positive electrode active material layer and a first positive electrode electrolyte layer onto a first surface of a positive electrode current collector;
sequentially applying a second positive electrode active material layer and a second positive electrode electrolyte layer onto a second surface of the positive electrode current collector; and
performing a pressing process on the second positive electrode electrolyte layer, the second positive electrode active material layer, the positive electrode current collector, the first positive electrode active material layer, and the first positive electrode electrolyte layer.

18. The method of claim 11, further comprising performing a heating process while performing a pressing process on the stack body.

19. The method of claim 11, wherein the stage stacks the first to third sheets n times while cycling through the first to third positions n times, and
n above is an integer of 3 or greater.

20. The method of claim 11, further comprising performing a taping process on the pressed stack body.
